(19) United States
(12) Patent Application Publication
(10) Pub. No.: US 2018/0280790 A1
(43) Pub. Date: Oct. 4, 2018

(54) A SMART TOY PLATFORM

(71) Applicant: ROYO BILI?IM TEKNOLOJILERI ANONIM SIRKETI, STANBUL (TR)

(72) Inventors: Murvet KIRCI, Istanbul (TR); Rahim ONER, Istanbul (TR); Onur YILDIRIM, Istanbul (TR)

(73) Assignee: ROYO BILI?IM TEKNOLOJILERI ANONIM ?IRKETI, ISTANBUL (TR)

(21) Appl. No.: 15/525,074

(22) PCT Filed: Nov. 9, 2015
(86) PCT No.: PCT/TR2015/050162

§ 371 Date: May 8, 2017

(30) Foreign Application Priority Data
Nov. 11, 2014 (TR) 2014/13250

(51) Int. Cl. A63F 9/24; A63F 13/213; A63F 3/00; A63F 13/214; A63F 13/235; A63F 13/24; A63F 13/843; A63H 33/26

(52) U.S. Cl. CPC A63F 9/24; A63F 13/213; A63F 3/00643; A63F 13/214; A63F 2009/2444; A63F 13/24; A63F 13/843; A63H 33/26; A63F 2003/00652; A63F 13/235

(57) ABSTRACT

The present invention relates to a smart toy platform, which provides various interactive games via an application installed in a smart device and basically comprises at least one object, at least one light source which is provided in each object and which emits infrared radiation, at least one electronic circuit, at least one board on which objects are placed, a plurality of sensors which are located on the board, at least one analog-digital converter which enables to convert. the analog data coining from the sensor into digital data, at least one controller which is adapted to control the digital data coming from the analog-digital converter and to generate the position data of each object on the board, at least one data communication unit which is located on the board and which enables the data generated by the controller to be transmitted to a smart device.

### CROSS REFERENCE TO RELATED APPLICATIONS

This application is the national phase entry of International Application No. PCT/TR2015/050162, filed on Nov. 9, 2015, which is based upon and claims priority to Turkish Patent Application No. 2014/13250 (TR), filed on Nov. 11, 2014, the entire contents of which are incorporated herein by reference.

### TECHNICAL FIELD

The present invention relates to a smart toy platform, which enables to provide an interactive game on a smart device by using the light emission feature of an LED, which is integrated to a toy, at a certain wavelength and detecting position, type and angle of a plurality of objects simultaneously on a certain area by the help of the said LED and phototransistor/photodiode sensor pair.

### BACKGROUND OF THE INVENTION

There are several applications for children to play with real objects and at the same time make use of the advantages brought by technology. In the majority of these applications, the objects with which the children play are detected by image processing methods. For example, by means of a camera placed on a tablet computer, the objects the children play with are transferred to an application in the computer and various games can be played by these applications. In other known applications, for example a bestseller toy character in the toy industry such as Furby is virtualized or one or more characters are enabled to be identified on a certain area via RFID method.

In these applications in the state of the art, in image processing method, the camera is required to see the object clearly and the objects cannot be easily detected at variable light conditions and complex environments. Height creates another problem for the objects used in image processing method and there is a possibility that an object blocks another object that is located behind it. Additionally the game area should also be within the angle of the camera and since the device camera is used in this product, the game cannot be played away from the smart device. In detection performed via RFID method, the method only detects the type of the objects thereon; there is no method for detecting their positions.

### SUMMARY OF THE INVENTION

The objective of the present invention is to provide a smart toy platform which enables a user to play a game via a single screen and multiple boards at the same time (for example in classroom applications) by transmitting information to a smart device by wired or wireless means. In the smart toy platform of the present invention, the communication between the board and the toy is provided by means of an infrared LED-phototransistor pair; and in addition to this, position and angle of the toy can also be found by means of a plurality of phototransistor/photodiode sensors provided on the board and an associated software algorithm.

The platform of the present invention provides more flexibility in comparison to the image processing method. As described above, there is no requirement for a camera to see the objects. Thus at the moment when the object is placed on the board it is detected and data are transferred to the application (smart device) instantaneously. Again, thanks to the fact that there is no dependency on a camera, the game can be played at any desired distance to the device.

Another advantage of the invention is that variable light conditions do not create any problems in detection of visual complexity of the environment where the game is played. In other words, since detection is not performed via image processing method in the present invention, the objects can easily be detected in a variable light condition and complex environment.

Multiple smart toy platforms can be connected to a single smart device by means of the desired wireless network structure; thus there is no requirement for having a separate smart device for each user.

Additionally, by means of the present invention, in addition to the information of type of the object used in RFID method, both position and angle information are also sent.

Furthermore, since it can be inventive conceptually, the system allows the child to design her/his product and add her/his drawings and the Legos s/he builds to the kits (the toys thereon). Also by means of the platform of the invention, objects of desired sizes can be defined.

Board games and FRP (Fantasy Role Play) games can be played on the system. The platform of the invention also includes these applications.

### BRIEF DESCRIPTION OF THE INVENTION

A smart toy platform developed to fulfill the objectives of the present invention is illustrated in the accompanying figures, in which:

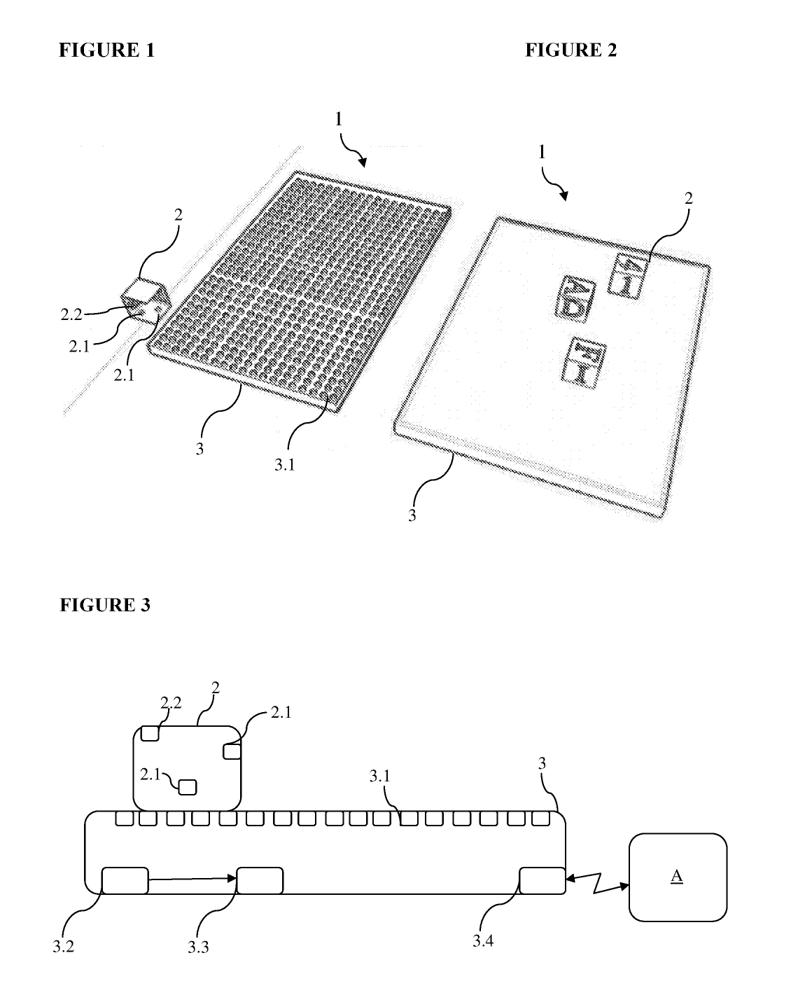

FIG. 1. is the perspective views of the open state of the smart toy platform of the present invention.

FIG. 2. is the perspective views of the closed state of the smart toy platform of the present invention.

FIG. 3. is the schematic view of the smart toy platform of the present invention.

The components in the figures are given reference numbers as follows:

1. Smart toy platform

2. Object
2.1. Light source
2.2. Electronic circuit

3. Board
3.1. Sensor
3.2. Analog-digital converter
3.3. Controller
3.4. Data communication unit

A. Smart device

### DETAILED DESCRIPTION OF THE INVENTION

The smart toy platform (1) of the present invention, which provides various interactive games via an application installed in a smart device (A) such as a phone, tablet computer, etc. by detecting position, type and, angle of one or more toys simultaneously, basically comprises
at least one object (2),
at least one light source (2.1) which is provided in each object (2) and which emits infrared radiation,
at least one electronic circuit (2,2), which is provided on each object (2) and comprises a processor adapted for performing digital coding specific for light sources (2.1).
at least one board (3) on which objects (2) are placed,
a plurality of sensors (3.1) which are located on the board (3) and which enable detection of the infrared radiations emitted from each light source (2.1), at least one analog-digital converter (3.2) which enables to convert. the analog data coming from the sensor (3.1) into digital data,
at least one controller (33) which is adapted to control the digital data coming from the analog-digital converter (3.2) and to generate the position data of each object (2) on the board (3),
at least one data communication unit (3.4) which is located on the board (3) and which enables the data generated by the controller (3.3) to be transmitted to a smart device (A).

The smart toy platform (1) of the present invention is operated by infrared technology; and is basically comprised of a board (3), which is connected to a smart device (A) via a wired or wireless data communication unit (3.4) and which detects the objects (2) placed thereon; and by using the feature of a light source (2.1) integrated to the objects (2) for emitting infrared radiation at a specific wavelength, detects position, type and angle of a plurality of objects (2) on a board (3) at the same time by the help of a light source (2.1) and sensor (3.1) pair, and thereby provides various interactive games via an application installed on a smart device (A) such as a phone, desktop computer, tablet computer, smart TV, smart board, etc.

In the preferred embodiment of the invention, there are provided an infrared light source (2.1) and an electronic circuit (2.2) which are integrated to the toys, i.e. objects (2), with which children are to play. In one embodiment of the invention, the said light source (2.1) is a LED (light emitting diode) and emits radiation at a wavelength in the range of 10 nm (nanometer) to 1000 μm (micrometer). There is preferably a processor in the said electronic circuit (2.2). Alternatively, a microcontroller, a digital signal processor (DSP) or any analog electronic circuit which can perform digital coding can be provided in the said electronic circuit (2.2) in place of the processor. By the help of the said processor, the light source (2.1) continuously emits light signal with digital coding logic. This digital coding process which is applied in order to distinguish each light source (2.1) and thus object (2) from each other is described in detail hereunder.

The communication between the object (2) and the board (3) is enabled by the light source (2.1), which is integrated to the object (2) and emits radiation at infrared wavelength, and the sensor (3.1), which is located on the board (3) and is activated (passes to conducting state) at infrared wavelength. These sensors (3.1) are lined up in a two dimensional matrix form under the entire detection area in the board (3) and the number thereof can be increased or decreased according to the size of the board (3).

In a preferred embodiment of the invention, the sensor (3.1) is a phototransistor or a photodiode.

If an object (2) on which there is an infrared light source (2.1) is placed on the board (3), the phototransistor sensor (3.1) that is closest to the said light source (2.1) gives a feedback close to zero volt reference voltage. At the same time, the other phototransistor sensors (3.1) around the said light source (2.1) are also affected by the light emission. Each phototransistor sensor (3.1), which is subjected to a different light intensity according to its distance to the light source (2.1) on the object (2), react in different ways, that is to say, their output voltages vary in proportion to this distance. Since this way a phototransistor sensor (3.1) closest to the light source (2.1) is subjected to a. greater light intensity, more variation is observed in its output voltage; while less variation is observed in the output voltage of the phototransistor sensor (3.1) farthest away from the light source (2.1).

Output voltage level of these phototransistor sensors (3.1) is first converted to digital data by means of the analog-digital converters (3.2) provided in the board (3). For this process, in one embodiment of the invention, a processor, in which au analog-digital converter (3.2) is integrated, is placed at each block containing 16 phototransistor sensors (3.1), and the data are processed in these inexpensive processors and the result data are sent to the controller (3.3). In another embodiment of the invention, output voltage level of the phototransistor sensors (3.1) can be sent to an analog-digital converter (3.2) by the help of an analog Mux/demux.

After the process of conversion to digital data, these voltage levels converted to digital data are continuously controlled by a controller (3.3) located preferably in the board (3). Thus, digitalized output data of the phototransistor sensors (3.1) coming from the analog-digital converters (3.2) are processed in the controller (3.3), and it can be determined in between which phototransistor sensors (3.1) each light source (2.1) is located.

Determining in between which phototransistor sensors (3.1) each light source (2.1) is located is realized as follows: for example in a system with 160 phototransistor sensors (3.1), 10 mux/processors are used. Each output pin of these processor-controlled muxes is connected to a different ADC (analog-digital converter (3.2)) channel of the processor and the said processor preferably switches all 16 channels, which are connected to these muxes, in order from 1 to 16. When the first channels of the said muxes are switched, the first channel of each mux is read by different ADC channels. Then, all of the second channels are read by the same ADC channels of the processor. This way switching continues for all of the channels. Since the points of the board (3) in x-y plane, to which the muxes and the channels connected thereto correspond, are predefined in the controller (3.3); positions of the phototransistor sensors (3.1), which react to the light source (2.1), and thus the object (2), to which the light source (2.1) is integrated, on the board (3) can be determined by the controller (3.3).

In one embodiment of the invention, the said controller (3.3) is a processor.

In order to distinguish the LEDs used as light sources (2.1) and thus the objects (2), to which the light sources (2.1) are attached, from each other, digital coding method is used as briefly described above. For this, them is provided one processor in electronic circuit (2.2) in each object, and this processor, for example in a period of 0.16 ms, performs coding for each light source (2.1) via special digital coding logic. For example, assuming that 256 different light sources (2.1), i.e. LEDs, will meet our requirement, 8 bit coding is performed. Thus, by means of the processor in the electronic circuit (2.2), each light source (2.1) that is digitally coded sends its own ID number to the phototransistor sensors (3.1) on the board (3).

ID numbers coded for the said light sources (2.1) are predefined in an application installed in the smart device (A). The image of the light source (2.1), whose ID number is determined, and the object (2) is matched at the stage of designing the application loaded to the smart device (A), and thus each light source (2.1) and thus the objects (2) including these light sources (2.1) thereon can be distinguished from each other during a game played via the application installed in the smart device (A).

In one embodiment of the invention, there is a second light source (2.1) on each object (2) and this way angles of the objects (2) on the board (3) can also be detected. When two different infrared. LEDs having different Ills are connected onto each object (2), the controller (3.3) sends the position of the two different IDs to the smart device (A) via the data communication unit (3.4). In the application installed in the smart device (A), two IDs are matched with the same object (2) and thus by means of the positions of the two Ills relative to each other on x-y plane, the angle at which the. object (2) is located on the board (3) can be determined.

In another embodiment of the invention, the angle of the object (2) is calculated by the controller (3.3) and only the ID, position and angle information of the object (2) are transferred to the smart device (A) by means of the data communication unit (3.4).

The data transferred from the light sources (2.1) to the phototransistor sensors (3.1) and the output voltage levels of the phototransistor sensors (3.1) which are digitalized by the analog-digital converter (3.2) are sent by wired or wireless means to the smart device (A) by the help of the data communication unit (3.4) (e.g. a Bluetooth module) via the controller (3.3) provided in the board (3), and the said objects (2) are displayed on the screen of the smart device (A) together with their positions and angles. In accordance with the said data that are transmitted, different games can be played interactively by means of the applications installed on the smart device (A).

In the present invention; multiple smart. toy platforms (1) can be connected to a single smart device (A) by means of the wireless network structure of the data communication unit (3.4) and thus there is no requirement for having a separate smart device (A) for each user.

What is claimed is:

1. A smart toy platform comprising
at least one object;
at least one board on which at least one object is placed;
wherein at least one light source is provided in each object; wherein each light source emits infrared radiation;
at least one electronic circuit wherein each object has at least one said electronic circuit;
wherein the electronic circuit comprises a processor adapted for performing digital coding specific for the at least one light source;
a plurality of sensors for detecting infrared radiation wherein said sensors are located on the board;
at least one analog-digital converter for converting analog data coming from the plurality of sensors into digital data;
at least one controller for controlling the digital data coming from the analog-digital converter and generating position data of each object on the board;
at least one data communication unit which is located on the board for transmitting the data generated by the at least one controller to a smart device;
wherein the smart toy platform provides various interactive games via an application installed in the smart device;
wherein the smart device can be a phone, tablet, or computer;
wherein the smart toy platform provides interactivity by detecting position, type, and angle of one or more toys simultaneously.

2. The smart toy platform according to claim 1, wherein the data communication unit communicates data wirelessly.

3. The smart toy platform according to claim 1, wherein the data communication unit communicates data via a wire.

4. The smart toy platform according to claim 1, by wherein the light source is a light emitting diode.

5. The smart toy platform according to claim 1, wherein the plurality of sensors are lined up in a two dimensional matrix form under a detection area in the board.

6. The smart toy platform according to claim 1, wherein the plurality of sensors are. activated by wavelengths in the infrared spectrum.

7. The smart toy platform according to claim 6, wherein the plurality of sensors, are subjected to a different light intensity according to their distance to the at least one light source on the at least one object, and whose output voltages vary in proportion to this distance.

8. The smart toy platform according to claim 1, wherein the plurality of sensors, are phototransistors.

9. The smart toy platform according to claim 1, wherein the plurality of sensors, which are photodiodes.

10. The smart toy platform according to claim 1, wherein the analog-digital converter converts the output voltage level of the plurality of sensors into the digital data.

11. The smart toy platform according to claim 1, wherein the at least one light source, digitally coded by the processor in the electronic circuit; wherein the at least one light source sends an ID Number belonging to the at least one light source to phototransistor sensors on the board.

12. The smart toy platform according to claim 1, wherein the at least one object comprises a second light source to enable detection of the at least one object's angle on the board.

13. The smart toy platform according to claim 12, wherein the controller, adapts to send the a position of two different infrared LED's to the smart device via the data communication unit when two different infrared LEDs having different IDs are connected onto each object.

14. The smart toy platform according to claim 13, wherein in the application installed in the smart device, two IDs are matched with a same object, and thus by means of the positions of the two IDs relative to each other on x-y plane, an angle at which the object is located on the board is determined.

15. The smart toy platform according to claim 13, by wherein the controller, is adapted to calculate the angle of the object and transfer the ID, position, and angle information of the object to the smart device by means of the data communication unit.

16. The smart toy platform according to claim 1, wherein one or more smart toy platforms is connected to a single smart device by means of the data communication units.
